(19) United States
(12) Patent Application Publication
(10) Pub. No.: US 2008/0171685 A1
(43) Pub. Date: Jul. 17, 2008

(54) Cleaning Composition and Method

(75) Inventors: Victoria Heather Cobb, Hull (GB); Mark Coke, Prestonpans East Lothian (GB); James Young, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough (Berkshire) (GB)

(21) Appl. No.: 11/912,370

(22) PCT Filed: Jun. 13, 2006
(86) PCT No.: PCT/GB2006/002170

§ 371 Date: Oct. 23, 2007

(30) Foreign Application Priority Data
Jun. 14, 2005 (EP) 05253644.8

(51) Int. Cl. C11D 17/08

(52) U.S. Cl. 510/433; 510/405

(57) ABSTRACT

A cleaning composition comprising from 80 to 98% by weight of water, from 1 to 25% percent by weight of an amphiphilic solvent, from 0.1 to 10 percent by weight of a volatile hydrocarbon and from 0.1 to 1% by weight of cationic surfactant exhibits good cleaning performance and a visual indication of activity. The composition is on or adjacent to a phase boundary of its phase diagram and exhibits self-induced surface motility of the Marangoni type.

This invention relates to the field of cleaning. It relates in particular to a cleaning composition, and to a method of cleaning.

EP-A-330379 describes the use of cleaning compositions which contain at least one ether alcohol, water and a hydrocarbon in a single phase, respectively in the percent weight ratios 90-50:2-36:25-0.9. The composition is said to be suitable for removing oil adherent from surfaces e.g. rock cuttings produced during drilling operations for oil. The compositions are made by simply mixing the chemicals, hand shaking, and then allowing the mixture to separate into three phases. The middle phase was the cleaning composition, and was extracted and used for cleaning tests. This middle phase contained the ether alcohol in major proportion, and lesser amounts of water and hydrocarbon.

A disadvantage of this system is the large amount of alcohol ether present in the cleaning composition. The use of large amounts of many alcohol ethers is now restrained by legislation relating to VOCs (Volatile Organic Components).

Co-pending applications PCT2005GB000449 and PCT2005GB000445, disclose a cleaning compositions comprising water, amphiphile and hydrocarbon which show self-induced motility driven by the Marangoni effect.

There is a need for cleansing compositions with reduced levels of volatile compounds which clean surfaces, particularly hard surfaces, effectively. There is also a need for cleansing compositions which provide a visual cue to the user that they are working.

In accordance with a first aspect of the present invention there is provided a cleaning composition comprising from 80 to 98% by weight of water, from 1 to 25% percent by weight of an amphiphilic solvent, from 0.1 to 10 percent by weight of a volatile hydrocarbon and from 0.1 to 1% by weight of cationic surfactant.

The composition may be in the form of a single phase or it may be present as two or three phases in mutual chemical equilibrium. Where the composition is a single phase, it has the advantage that it does not need to be mixed or shaken prior to use. Where the composition is in the form of 2 or 3 phases, the visual cleaning indication due to motility of the system is more visible. Preferably the composition is adjacent to a phase boundary on the three-component (water, amphiphilic solvent, hydrocarbon) phase diagram for the composition (cationic surfactant level being kept constant). By this it is meant that a change in relative weight percentages of these three components of the composition caused by loss of only one component, whereby the weight percentage of that component is reduced by an absolute value of 1% or less, preferably 0.5% or less, more preferably 0.1% or less (expressed as percentage by weight of the total weight of the total composition), leads to a change in the number of phases present in the composition, for instance changing from a single phase to a 2 or 3 phase mixture.

In this specification when a percentage value is given for a component, it denotes the percentage by weight of that component, based on the total weight of the composition of which the component is part.

For the purpose of this specification an amphiphilic solvent is defined as a compound which possesses an affinity for an apolar compound and for a polar compound. Suitably it forms a loose association in a composition, coupling together other components of the composition, without forming a strongly micellar or lamellarlstructure, in the manner of a classical surfactant. Preferably it does not associate strongly with surfaces.

For some aspects, such as not needing to be shaken prior to use, the water the amphiphilic solvent and the hydrocarbon preferably co-exist without separating from each other, as layers. When the composition comprises 2 or more phases, it is preferably shaken prior to use.

Suitably, the compositions of the invention comprise from 80 to 98% by weight of water, preferably from 90 to 98%, more preferably from 93 to 98%.

Preferably the composition comprises from 0.5 to 25% by weight of amphiphilic solvent, preferably from 0.5 to 15% by weight, more preferably from 0.7 to 8% by weight. Mixtures of amphiphilic solvents may be used.

Suitable amphiphilic solvents include substituted pyrrolidones, especially 1-alkyl-2-pyrrolidones. Preferably the alkyl group has, on average, 4 to 16 carbon atoms, more preferably 6 to 14 carbon atoms, and most preferably 8 to 12 carbon atoms. Preferably the alkyl group is linear. 1-octyl 2-pyrollidone is particularly suitable.

Quaternary N-alkylaldonamides may also be used as the amphiphilic solvent, for instance N-decylisosaccharinamide or N-octylribonamide and mixtures thereof.
Short alkyl chain alkyl glucosides, preferably with an alkyl chain length of C₁₀ or less, more preferably C₈ or less are also suitable amphiphilic solvents. Mono-, di-, tri, or tetra-glucosides or mixtures thereof are preferred.

Suitable amphiphilic solvents include glycol ethers and these are particularly preferred.

Preferred glycol ethers for use as the amphiphilic solvent are compounds of the formula R¹O(RO)ₙH (I) in which R is a C₁-C₈ alkylene group (preferably C₁-C₄), n is at least 1 (preferably 2-4) and R¹ is a C₁-C₈ alkyl group (preferably C₁-C₄) or, especially, an optionally substituted aryl group). A preferred optionally substituted aryl group is an optionally substituted phenyl group. Substituents of an aryl or phenyl group include C₁-C₄ alkyl groups, C₁-C₄ alkoxy groups, C₁-C₄ haloalkyl groups, cyano groups, amido groups, amine groups, and halogen atoms. Preferred halogen atoms, including comprised within haloalkyl groups, include fluorine, chlorine and bromine atoms. There may suitably be 1-3 substituents. Preferably, however, an aryl or phenyl group is unsubstituted.

Specific examples of suitable glycol ethers not having an aromatic group include:

ethoxypropoxypropanol (EDP)

ethoxyethoxypropanol

propoxyethoxypropanol

propoxypropoxypropanol

butoxypropoxyethanol

butoxybutoxyethanol

butoxyethoxyethanol (BDGE)

ethoxypropanol (EP)

butoxyethanol (BE)

butyl diglycol ether.

Specific examples of suitable, and preferred, glycol ethers having an aromatic group include:

ethylene glycol phenyl ether (EPh)

phenoxypropanol (PhP)

phenoxypropoxypropanol (PhDP).

Particularly preferred are 2-butoxyethanol, diethylene glycol monohexyl ether or phenoxyethanol, and mixtures thereof.
Short chain alcohols are suitable amphiphilic solvents for use in compositions of the invention, but are not preferred when used as the sole amphiphilic solvent present. Particularly suitable for use in combination with other amphiphilic solvents as described above are ethanol, propanol, isopropanol, n-butanol and t-butanol and other alcohols up to n-decanol. Mixtures of these alcohols with other amphiphilic solvents may also be used in order to modify the phase boundaries relating to the compositions of the invention. The alcohol is preferably present in an amount of up to 0.04 weight percent.

Especially preferred amphiphilic solvents are compounds which at no concentration are classified as VOCs as set out in the regulations of the US Government Environmental Protection Agency (EPA) for the envisaged application (preferably as cleaners in a household environment) at the priority date of this patent application. Other preferred amphiphilic solvents are compounds which are classified as VOCs by the EPA regulations but only at particular concentration levels; and which are present below such levels, in the composition of the invention.

If water and an amphiphilic solvent of use in the present invention are shaken together in a two-phase zone of the phase diagram, away from a phase boundary, two easily-visible phases will form. In some cases the water-rich phase will be below the amphiphilic solvent-rich phase (Amphiphilic solvents A). In other cases the water-rich phase will be above the amphiphilic solvent-rich phase (amphiphilic solvents B). Provided that the proportions can be adjusted so that the composition is in accordance with the first aspect, the use of all such amphiphilic solvents A and B, of differing densities, is covered. Preferably, however, the amphiphilic solvents used in this invention are of the type B.

Especially preferred glycol ethers are compounds having a vapour pressure of less than 0.1 mmHg at 20° C.

It is particularly preferred that the amphiphilic solvent is at least partially miscible with water. Preferably, the amphiphilic solvent is soluble in water at 25° C. at a level of 0.5% by weight of water or more (i.e. 0.5 grams of solvent per 100 grams of water), more preferably, 1.5% or more, even more preferably 3.5% or more. The solubility of the solvent in water is preferably less than 10% by weight of water, more preferably less than 6%. This is in order to optimise the mobility of the composition when exposed to the atmosphere on a surface. A particularly preferred suitable amphiphilic solvent is dipropylene glycol monobutyl ether (commercially available as Dowanol™ DPnB).

The composition of the invention further contains a hydrocarbon. The hydrocarbon is preferably insoluble in water, by which it is meant that its solubility in distilled water at 25° C. is 0.001% by weight of solution or less. Suitably the compositions of the invention comprise from 0.1 to 10% by weight of hydrocarbon, preferably from 0.3 to 7% by weight, more preferably from 0.5 to 3% by weight. The upper limit of the level of hydrocarbon is preferably limited as describe above such that the level of volatile material released to the atmosphere during use of the composition is minimised. Mixtures of suitable hydrocarbons may be employed in the compositions of the invention.

The hydrocarbon is suitably a paraffinic, including isoparaffinic compounds. The hydrocarbon may suitably be a hydrocarbon fragrance. Preferably it is a liquid under ambient conditions. Suitably the hydrocarbon has from 5 to 15 carbon atoms, preferably from 8 to 12, more preferably from 9 to 11. When the hydrocarbon is a mixture, as will often be the case, these definitions still apply, as mean values of the number of carbon atoms per molecule.

Preferably a hydrocarbon present is significantly more volatile than the water or the amphiphilic solvent. By volatile it is meant that a material has a vapour pressure of 0.2 mmHg or more at 20° C.

A monitor of the suitability of the hydrocarbon when it is an isoparaffinic material, is the IBP (initial boiling point for distillation) as measured by ASTM D86. Suitably, the IBP in degree Celcius is 220 or less, preferably 200 or less, more preferably 180 or less.

In this specification when we mention an amphiphilic solvent or a hydrocarbon it is to be understood that there may be more than one of a said amphiphilic solvent or a hydrocarbon present. The weight percentage definitions denote the total complement of amphiphilic solvent or hydrocarbon compounds present. This also applies to cationic surfactant: more than one cationic surfactants may be used in admixture, and the term cationic surfactant applies to such an admixture.

Compositions of the invention also comprise from 0.1% to 1% by weight of a cationic surfactant, preferably from 0.2 to 0.5% by weight.
Suitable cationic surfactants are those which comprise a quaternary nitrogen in their molecular structure such as alkyl pyridinium or alkyl quaternary ammonium salts.
Preferred cationic surfactants for use with the invention are quaternary ammonium compounds which have the structural formula:

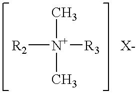

wherein R₂ and R₃ are the same or different C₈-C₂₂ (preferably C₁₂-C₁₈) alkyl or C₈-C₂₂ (preferably C₁₂-C₁₈)alkylethoxy, or R₂ is C₈₋₂₂ (preferably C₁₂-C₁₈)alkyl, C₈₋₂₂ (preferably C₁₂-C₁₈)alkylethoxy, C₈₋₂₂ (preferably C₁₂-C₁₈)alkylphenolethoxy and R₃ is benzyl, and X is a halide, for example chloride, bromide or iodide, or is a methosulfate anion. The alkyl groups recited in R₂ and R₃ may be straight-chained or branched, but are preferably substantially linear.
Other preferred cationic surfactants suitable for use in compositions of the invention have the structural formula:

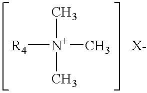

Wherein R₄ is C₈-C₂₂ (preferably C₁₂-C₁₈) alkyl or C₈-C₂₂ (preferably C₁₂-C₁₈)alkylethoxy.

Particularly useful cationic surfactants include compositions which include a single quaternary compound, as well as mixtures of two or more different quaternary compounds. Particularly useful cationic surfactants which are also quaternary germicides include those which are described as being a blend of alkyl dimethyl benzyl ammonium chlorides; BARDAC® 205M, BARDAC® 2050, BARDAC® 2080, BARDAC® 2250, BTC® 812, BTC® 818 and BTC® 1010 which are described as being based on dialkyl(C₈-C₁₀)dimethyl ammonium chloride; BARDAC® 2250 and BARDAC® 2280 or BTC® 1010 which are described as being a composition,which includes didecyl dimethyl ammonium chloride; BARDAC® LF and BARDAC® LF 80 which are described as being based on dioctyl dimethyl ammonium chloride; BARQUAT® MB-50, BARQUAT® MB-80, BARQUAT® MX-50, BARQUAT® MX-80, BARQUAT® OJ-50, BARQUAT® OJ-80, BARDAC® 208M, HYAMINE® 3500, HYAMINE® 3500-NF, BTC® 50, BTC® 824, BTC® 835, BTC® 885, BTC® 2565, BTC® 2658, BTC® 8248 or BTC® 8358 each described as being based on alkyl dimethyl benzyl ammonium chloride (benzalkonium chloride); BARQUAT® 4250, BARQUAT® 4280, BARQUAT® 4250Z, BARQUAT® 4280Z, BTC® 471, BTC® 2125, or BTC® 2125M each described as being a composition based on alkyldimethylbenzyl ammonium chloride and/or alkyldimethylethylbenzyl ammonium chloride; BARQUAT® MS-100 or BTC® 324-P-100 each described as being based on myristyldimethylbenzyl ammonium chloride; HYAMINE® 2389 described as being based on methyldodecylbenzyl ammonium chloride and/or methyldodecylxylene-bis-trimethyl ammonium chloride; HYAMINE® 1622 described as being an aqueous solution of benzethonium chloride; as well as BARQUAT® 1552 or BTC® 776 described as being based on alkyl dimethyl benzyl ammonium chloride and/or dialkyl methyl benzyl ammonium chloride, BARQUAT® 50-MAB described as being based on alkyldimethylethyl ammonium bromide and LONZABAC® -12.100 described as being based on an alkyl tertiary amine. (Each of these recited materials is presently commercially available from Lonza, Inc., Fairlawn, N.J. and/or from Stepan Co., Northfield Ill.).

Alkyl dimethyl benzyl ammonium halides (benzalkonium halides) are particularly preferred, especially C₁₂ to C₁₈ dimethyl benzyl ammonium chloride.
Alkyl (preferably C₁₂ to C₁₈) trimethyl ammonium halides (preferably bromides or chlorides) are also highly preferred for the cationic surfactant.
Dialkyl (preferably C₈ to C₁₀) dimethyl ammonium halides (preferably bromides or chlorides) are also particularly preferred for the cationic surfactant.
Another suitable cationic surfactant which is effective is hexahydro-1,3,5-tris(2-hydroxyethyl)-S-triazine.

Suitably the composition may optionally contain an electrolyte, preferably an ionic salt. Suitable examples include alkali metal salts, especially halides. Most preferred, for reasons which include cost and safety, is sodium chloride.

An electrolyte may be used to alter the phase diagram, shifting phrase boundaries so that the composition is on or adjacent to a phase boundary, as preferred by the first aspect of the present invention. When electrolyte is present, it is included with the water, treating water and electrolyte as a single component for the purpose of drawing up a three component phase diagram.

It is highly preferred for the compositions of the invention to include a fragrance in order to make more acceptable the odour of the compositions in a household cleansing composition. Preferably at least 0.1%.by weight of fragrance is present, more preferably 0.4% or more, but preferably 1% or less, more preferably 0.8% or less. The fragrance is included with the hydrocarbon for the purpose of drawing up the three-component phase diagram of the composition. By fragrance is meant perfumer's oil without any base or extender included.

Compositions of the present invention may also comprise a nonionic surfactant, preferably in an amount of up to 5 wt % based on the total weight of the composition. A preferred amount is up to 3 wt %, more preferably from 1 to 3 wt %. Suitable nonionic surfactants have a hydrophobic moiety such as C₈₋₂₀ alcohol, C₈₋₁₈ mono- or di-alkylphenol or C₆₋₂₀ fatty acid amide, and a hydrophilic moiety such as 2 to 30 alkylene oxide units. Suitable examples of such surfactants are C₈₋₁₆ straight chain alcohols condensed with 6 to 12 moles of ethylene oxide

Examples of nonionic surfactants are alcohol ethoxylate propoxylate, lauryl alcohol LOEO, lauryl dimethyl betaine, lauryl alcohol 3EO, C₉₋₁₁ alcohol 6EO, C₁₂₋₁₆ alcohol ethoxylated with 5 to 15 EO, nonyl phenoxy ethanol, C₁₃₋₁₅ alcohol ethoxylates, ethoxylated oleylamine, fatty alcohol 7EO, PEG15 tallow amine and polyoxyethylene(8) octylphenyl ether. Most preferred are Neodol 91-6 from Shell Chemicals, Lutensol XL79 from BASF, lgepal BC/9 from Rhodia, Triton X-l00 from Acros Organics and lauryl dimethyl amine oxide.

Compositions of the present invention may include low levels, preferably less than 5% by weight, more preferably less 1% by weight, of the composition, of other conventional adjuncts used in household cleaning-products, provided that these do not have a substantial effect on the phase behaviour of the composition. Examples are monoethanolamine, sulphonic acid and formic acid. In terms of drawing up a three-component phase diagram for the system, the skilled person would assign such components to be included with the water, amphiphilic solvent or hydrocarbon corner of the phase diagram based upon the Hansen solubility parameter for the component. Biostatic agents such as cationic biostats or suitably PCMX (parachlorometaxylenol) may also be incorporated in compositions of the invention. Bleach systems such as or peroxide-based bleaches may also be used in compositions of the invention.

Remarkably, we have found that compositions of the invention may apparently exhibit behaviour of the Marangoni type. When a jar of a preferred composition of the invention is opened and exposed to the environment the surface may be seen to “twitch”. This effect is believed to be due to surface tension gradients, perhaps allied to crossing of phase boundaries, when volatile compounds evaporate. We have observed such compositions, in which, when the lid is replaced on the jar, the “twitching” stops. The “twitching” may be if the composition is pipetted onto a surface.

By “twitching” we mean that the surface of the composition exhibited motility not induced by an external agent, such as an object applied to it; in other words a self-induced motility.

In accordance with a second aspect of the present invention there is provided a cleaning composition comprising water, a hydrocarbon and an amphiphilic solvent as detailed hereinbefore, which composition exhibits Marangoni behaviour when exposed to air. Preferably the composition exhibits Marangoni behaviour only when exposed to air. Preferably the composition is in the form of 2 or 3 phases in mutual equilibrium prior to exposure to the air.

For the purpose of this specification the Marangoni effect may be defined as the effect in a liquid when surface tension gradients cause movement of the liquid. The surface tension gradients may result from concentration changes (Gibbs effect), which may themselves arise from evaporation, or from inadequate mixing, following separation or segregation in a container, or by the application of a stress, for example a shear force (as by a wiping action).

Without wishing to be bound by theory, it is thought that the Marangoni effect may give rise to cleaning benefits exhibited by compositions of the invention. Compositions exhibiting the Marangoni effect may exhibit a tendency to “creep” into small spaces. Evaporation of a compound may lead to changes in surface tension and to surface motility, causing the composition to move, for example into and then out of a crack, drawing soils with it. The use of amphiphilic solvents may assist separation of dirt from a substrate. Amphiphilic solvents generally do not promote adhesion with a surface but they may wet well. Thus amphiphilic solvent-containing compositions which exhibit the Marangoni effect may move into small interstices or may move between a surface and a soil deposit, “lifting” the latter.

In accordance with a third aspect of the present invention there is provided a method of cleaning a soiled substrate, comprising the application to the soiled substrate of a composition of the first and/or second aspect of the present invention, as defined above.

Another aspect of the invention is the use of compositions as described above for household substrate cleaning.
Another aspect of the invention provides a packaged household cleansing composition, wherein the cleansing composition is a composition as described above for the other aspects of the invention.

The substrate may be, for example, a hard surface, for example, a surface in the kitchen or bathroom, including a work surface, floor, tile, glass, sanitaryware item, window, crockery item or a domestic appliance; or a fabric surface, for example a clothing or upholstery item. It has been found surprisingly that the compositions of the invention are particularly effective for the cleaning of soil from corners, cracks and crevices which are otherwise difficult to clean. Without being bound by any scientific explanation, it is thought that this is related to the Marangoni-driven movement of the compositions of the invention.

The soiling on the substrate may, for example, be grease, a protein stain, wine, fruit juice or make-up.

Preferred compositions of the present invention are provided in containers which have a manually operable pump such as a “trigger spray”, or in containers from which the contents are poured, or expressed by squeezing the container, or in aerosol dispensers. In aerosol dispensers the hydrocarbon of the composition may be the same as the propellant, and evaporation of propellant could itself induce a Marangoni effect.

Containers containing ready-to-use compositions of the invention constitute a further aspect of the present invention, notably containers adapted to deliver such compositions directly to hard surfaces (for example aerosols and “trigger sprays”). Containers containing aqueous dilutable compositions (i.e. comprising the components of the composition without water, the water being added by the user of the product prior to use) constitute a still further aspect. This gives the advantage of reduced packaging and transport costs.

The invention will now be further described, by way of example, with reference to the following examples.

Example 1 comprises (expressed as percent by weight of the composition):

| | |
|---|---|
| Dowanol ™ DPnB | 2.6% |
| Isopar ™ G | 0.5% |
| Dowanol ™ PnP | 0.5% |
| Cationic BTC 8358 | 0.125% |
| Deionised Water | 96.275%. |

The composition of example 1 was found to be a highly effective hard surface cleaner, and also demonstrated vigorous Marangoni-type movement when placed on melamine surface open to the atmosphere at 25° C.
Compositions containing the four ingredients listed in table 1 (Dowanol™ DPnB, Isopar™ G, Dowanol™ PnP and BTC 8358) were prepared in admixture with deionised water (to 100% by weight). The columns in the table show the percent by weight of each ingredient in the composition.
Dowanol™ DPnB is 1-(2-butoxy-1-methylethoxy)-2-propanol.
Isopar™ G is a volatile isoparaffinic hydrocarbon from ExxonMobil™ with a distillation IBP (initial boiling point by ASTM D860 of 118° C.
Dowanol™ PnP is is 1 propoxy-2-propanol.
BAC 83598 is n-alkyl dimethyl benzalkonium chloride. The cationic surfactant was added as a solution of 80% by weight of active in water. The figures in the table refer to the cationic surfactant expressed as 100% by weight of cationic surfactant.

TABLE 1

| | | | | | | Movement |
|---|---|---|---|---|---|---|
| | | | | Movement | Movement | on |
| | Isopar | | BTC | on white | on | Stainless |
| DPnB | G | PnP | 8358 | tile | Melamine | Steel |
| 1 | 0.1 | 1 | 0.25 | 2 | 2 | 3 |
| 1 | 1 | 1 | 0 | 0 | 0 | 0 |
| 10 | 0.1 | 1 | 0.25 | 0 | 0 | 0 |
| 1 | 0.1 | 0 | 0.25 | 1.5 | 0 | 0 |
| 1 | 0.1 | 0 | 0 | 1.75 | 0 | 0 |
| 10 | 1 | 0 | 0 | 0 | 0 | 0 |
| 10 | 1 | 1 | 0.25 | 5 | 5 | 0 |
| 10 | 0.1 | 0 | 0 | 0 | 0 | 0 |
| 10 | 0.1 | 0 | 0.25 | 0 | 0 | 0 |
| 10 | 1 | 0 | 0.25 | 5 | 3.5 | 0 |
| 1 | 0.1 | 1 | 0 | 0 | 0 | 0 |
| 10 | 1 | 1 | 0 | 0 | 0 | 4 |
| 1 | 1 | 1 | 0.25 | 2 | 5 | 5 |
| 10 | 0.1 | 1 | 0 | 0 | 0 | 0 |
| 5.5 | 0.55 | 0.5 | 0.125 | 5 | 5 | 5 |
| 1 | 1 | 0 | 0.25 | 2.5 | 4 | 2 |
| 1 | 1 | 0 | 0 | 0 | 0 | 0 |

Movement was scored on a scale from 0 to 5, where 0 corresponds to no movement and 5 corresponds to movement similar in magnitude to that obtained by example 1.
It can be seen from the table, that in order to consistently obtain significant movement on 3 or more of the selected surfaces, amphiphilic solvent, hydrocarbon and cationic surfactant are needed in combination with water.

1. A cleaning composition comprising from 80 to 98 percent by weight of water, from 0.5 to 25% percent by weight of an amphiphilic solvent, from 0.1 to 10 percent by weight of a volatile hydrocarbon and from 0.1 to 1% by weight of cationic surfactant.

2. A cleaning composition as claimed in claim 1, wherein the water the amphiphilic solvent, the hydrocarbon and the cationic surfactant co-exist as a single phase without separating from each other as layers.

3. A cleaning composition as claimed in claim 1, wherein the amphiphilic solvent is a glycol ether.

4. A cleaning composition as claimed in claim 3, wherein the glycol ether is a compound of the formula R¹O(RO)ₙH in which R is a C₁-C₈ alkylene group, n is at least 1 and R¹ is a C₁-C₈ alkyl group, or is an optionally substituted aryl group.

5. A cleaning composition as claimed in claim 1, wherein the amphiphilic solvent is a 1-alkyl-2-pyrrolidone.

6. A composition according to claim 1 wherein the cationic surfactant is an alkyl benzyl dimethyl ammonium chloride.

7. A composition according to claim 1 which also comprises up to 5 percent by weight of a nonionic solvent.

8. A cleaning composition comprising water, a hydrocarbon an amphiphilic solvent and a cationic surfactant, which composition exhibits Marangoni behaviour when exposed to air.

9. A method of cleaning a soiled substrate, comprising the application to the soiled substrate of a composition as claimed in claim 1.

10. (canceled)

11. A packaged household cleaning product comprising a position according to.
